(19) United States
(12) Patent Application Publication
(10) Pub. No.: US 2014/0241011 A1
(43) Pub. Date: Aug. 28, 2014

(54) REACTOR, CONVERTER, AND POWER CONVERTER APPARATUS

(71) Applicants: Yasushi Nomura, Osaka-shi (JP); Izumi Memezawa, Osaka-shi (JP); Hiroshi Teraniti, Osaka-shi (JP); Atsushi Ito, Osaka-shi (JP)

(72) Inventors: Yasushi Nomura, Osaka-shi (JP); Izumi Memezawa, Osaka-shi (JP); Hiroshi Teraniti, Osaka-shi (JP); Atsushi Ito, Osaka-shi (JP)

(73) Assignees: SUMITOMO ELECTRIC INDUSTRIES, LTD., Osaka-shi (JP); AUTONETWORKS TECHNOLOGIES, LTD., Yokkaichi-shi (JP); SUMITOMO WIRING SYSTEMS, LTD., Yokkaichi-shi (JP)

(21) Appl. No.: 14/352,295

(22) PCT Filed: Sep. 5, 2012
(86) PCT No.: PCT/JP2012/072619

§ 371 Date: Apr. 16, 2014

(30) Foreign Application Priority Data
Oct. 19, 2011 (JP) 2011-229980

(51) Int. Cl. H01F 27/02; H02M 7/42; H02M 3/155

(52) U.S. Cl. CPC H01F 27/02; H02M 3/155; H02M 7/42
USPC 363/13; 323/355; 336/90

(57) ABSTRACT

A reactor of the present invention includes a coil 2, a magnetic core 3 in which the coil 2 is disposed, and a case that stores a combined product 10 made up of the coil 2 and the magnetic core 3. The case includes a bottom plate portion 40 made of a metal material, and a sidewall portion that is attached to the bottom plate portion 40 to surround the combined product 10. A joining layer 42 that fixes the coil 2 is provided at the inner face of the bottom plate portion 40. The region provided with the joining layer 42 has been subjected to surface roughening treatment. When anodic oxidation treatment is carried out as the surface roughening treatment, the bottom plate portion 40 includes an anodic oxide layer 43. The surface roughening treatment increases the contact area between the bottom plate portion 40 and the joining layer 42, whereby the joining strength between the bottom plate portion 40 and the coil 2 can be enhanced. Since the bottom plate portion 40 and the coil 2 are strongly joined to each other, the heat of the coil 2 can be efficiently transferred to the installation target via the bottom plate portion 40. Thus, an excellent heat dissipating characteristic is exhibited.

### TECHNICAL FIELD

The present invention relates to a reactor used as a constituent element of a power converter apparatus such as an in-vehicle DC-DC converter mounted on a vehicle such as a hybrid vehicle, a converter including the reactor, and a power converter apparatus including the converter. In particular, the present invention relates to a reactor that exhibits high joining strength between a coil and a case, and that exhibits an excellent heat dissipating characteristic.

### BACKGROUND ART

A reactor is one of the components of a circuit that performs a voltage step up or step down operation. For example, Patent Literature 1 discloses a reactor used for a converter mounted on a vehicle such as a hybrid vehicle. The reactor includes a coil having a pair of coil elements, an annular magnetic core at which the coil is disposed and a closed magnetic path is formed, a box-like case that stores a combined product made up of the coil and the magnetic core, and a sealing resin that is packed in the case. In connection with the reactor, the sealing resin is packed in the clearance between the bottom face of the case and the face of the coil on the case side, such that the sealing resin insulates the case and the coil from each other. Further, in connection with the reactor, it is proposed to form insulating thin film coating on the inner bottom face of the case in order to further enhance insulation.

A reactor such as an in-vehicle reactor is fixed to an installation target such as a cooling base and cooled during operation. Accordingly, the case of the reactor is representatively made of aluminum or alloy thereof such that the case can be used as a heat dissipation path (see paragraph 0024 of Description of Patent Literature 1). Further, Patent Literature 1 discloses a structure in which a support portion for the magnetic core is provided at the bottom face of the case, to allow heat to be dissipated from the magnetic core via the case.

### CITATION LIST

### Patent Literature

Patent Literature 1: Japanese Unexamined Patent Publication No. 2009-099596

### SUMMARY OF INVENTION

### Technical Problem

Conventional reactors are desired to achieve a further improvement in the heat dissipating characteristic.

In connection with the reactors, since the coil emits heat as it is energized, it is desired that the heat of the coil is efficiently transferred to the above-described installation target. In the reactor of Patent Literature 1, the sealing resin is interposed between the coil and the case. Therefore, while excellent insulation is exhibited, it is difficult to further improve the heat dissipating characteristic.

Further, a reactor including a conventional case is poor in assemblability.

Since the coil is representatively made of copper and the magnetic core is representatively made of iron or steel, a combined product made up of the coil and the core is a heavy item. With the conventional reactor, the combined product being a heavy item can only be inserted from the opening portion above the case, and hence assemblability is poor.

The inventors of the present invention have considered a structure in which the case is made of separate members, i.e., a bottom plate portion and a sidewall portion. The bottom plate portion is made of a metal material, and the coil is joined to the bottom plate portion. Employing the mode in which separate members are employed, the combined product can be easily placed on the bottom plate portion. Furthermore, assembling the bottom plate portion to the sidewall portion after the combined product is disposed, the state where the combined product is stored in the case can be attained. Accordingly, with this structure, the burden associated with shifting of the heavy item can be reduced, and hence excellent assemblability is exhibited. Further, since the bottom plate portion is made of metal which is generally excellent in thermal conductivity, and the coil is directly joined to the bottom plate portion, the distance between the coil and the bottom plate portion can be shortened. This also contributes toward enhancing the heat dissipating characteristic.

However, as a result of consideration, the inventors of the present invention have found that, when an adhesive agent is directly disposed on the bottom plate portions in the structure described above, the coil and the bottom plate portion may be separated from each other in some cases. This may be attributed to native oxide or the like being formed on the surface of the bottom plate portion to hinder adhesion between the bottom plate portion and the adhesive agent. This separation makes it difficult for the heat of the coil to be efficiently transferred to the installation target via the bottom plate portion. Thus, a reduction in the heat dissipating characteristic is invited.

Accordingly, an object of the present invention is to provide a reactor in which the joining strength between the coil and the case is high, and with which an excellent heat dissipating characteristic is exhibited. Further, another object of the present invention is to provide a converter including the reactor exhibiting an excellent heat dissipating characteristic, and a power converter apparatus including the converter.

### Solution to Problem

The present invention achieves the objects stated above by employing a case in which a bottom plate portion and a sidewall portion are separate members, in place of employing a case being a mold product in which the bottom plate portion and the sidewall portion are integrally molded. Further, in fixing a coil to the metal-made bottom plate portion via a joining layer, treatment for enhancing adhesion between the bottom plate portion and the joining layer is carried out.

A reactor of the present invention includes a coil, a magnetic core in which the coil is disposed, and a case that stores a combined product made up of the coil and the magnetic core. The case includes a bottom plate portion, a sidewall portion that is a member independent of the bottom plate portion, and a joining layer that is provided at the inner face of the bottom plate portion to fix the coil. The bottom plate portion is made of a metal material. The sidewall portion is attached to the bottom plate portion and surrounds the combined product. In connection with the reactor, in the inner face of the bottom plate portion, a region at least provided with the joining layer has been subjected to surface roughening treatment.

In the case included in the reactor of the present invention, the bottom plate portion and the sidewall portion are separate members. Therefore, as described above, the combined product made up of the coil and the magnetic core may be previously disposed in the bottom plate portion, and then the bottom plate portion and the sidewall portion may be integrated, such that the combined product is stored in the case. Further, since the reactor of the present invention includes the joining layer, the combined product (the coil) can be surely fixed to the case irrespective of the presence or absence of the sealing resin. Accordingly, the reactor of the present invention exhibits excellent assemblability as compared to the conventional integrally molded case.

Further, in connection with the reactor of the present invention, the bottom plate portion is made of a material that is generally excellent in thermal conductivity, i.e., a metal material. To this bottom plate portion, the coil is fixed via the joining layer. Since the coil is disposed in close proximity to the bottom plate portion by the joining layer, the heat of the coil can be efficiently transferred to the bottom plate portion. In particular, in connection with the reactor of the present invention, since the region in the surface of the bottom plate portion where the joining layer is provided has been subjected to surface roughening treatment, a sufficiently great contact area can be secured between the bottom plate portion and the joining layer. Hence, the joining strength between the bottom plate portion and the joining layer is high. Accordingly, since the bottom plate portion and the coil are strongly fixed to each other via the joining layer, the heat of the coil can be efficiently transferred to the installation target via the bottom plate portion. Based on these points, the reactor of the present invention exhibits an excellent heat dissipating characteristic.

As one mode of the reactor of the present invention, the surface roughening treatment may be anodic oxidation treatment, and the bottom plate portion may include an anodic oxide layer at the inner face of the bottom plate portion.

By the anodic oxidation treatment, a large amount of material or a material of a great area can be subjected to surface roughening treatment with ease, and hence excellent productivity is exhibited. Further, since a large amount of OH group is present on the surface of the anodic oxide layer, strong hydrogen bonds with the constituent material of the joining layer such as an adhesive agent may occur. Hence, adhesion with the joining layer is excellent. Further, since dimples whose diameter is about 3 μm to 400 μm are formed on the surface of the anodic oxide layer, the surface area can be increased by about 1.8 times as compared to the situation where solely the bottom plate portion is provided. The metal forming the bottom plate portion and the anodic oxide layer exhibit very strong adhesion. Based on these points, the present mode can effectively enhance the joining strength between the bottom plate portion and the joining layer via the anodic oxide layer. Further, since the anodic oxide layer is excellent in the insulating performance, the present mode can enhance insulation between the coil and the metal-made bottom plate portion.

As one mode including the anodic oxide layer, the thickness of the anodic oxide layer may be 2 μm or more and 20 μm or less.

In the anodic oxide layer, representatively, a multitude of very minor fine pores whose diameter is about 300 nm to 700 nm are present. In the mode in which the thickness of the anodic oxide layer is 2 μm or more, the anodic oxide layer has a sufficient thickness. Accordingly, fine pores having a great depth are present, and the contact area between the anodic oxide layer and the joining layer is great. Thus, the joining strength between the anodic oxide layer and the joining layer, and eventually the joining strength between the coil and the bottom plate portion can be enhanced. Further, since the thickness of the anodic oxide layer falls within the above-described range, a reduction in thermal conductivity attributed to the presence of the anodic oxide layer can be suppressed. Accordingly, the present mode can achieve excellent joining strength and heat dissipating characteristic.

As one mode including the anodic oxide layer, the anodic oxide layer may have a crack portion originating from the surface of the anodic oxide layer to reach a metal material forming the bottom plate portion. The crack portion may be packed with the constituent material of the joining layer.

As a result of the examination conducted by the inventors of the present invention, it was found that the joining strength can be further enhanced when the anodic oxide layer is formed to have a thickness of certain degree (particularly 9 μm or more, preferably 12 μm or more), because cracks reaching the bottom plate portion occur at the anodic oxide layer by the later thermal hysteresis (e.g., when the constituent material of the joining layer (representatively, an adhesive agent) is cured, or when the sealing resin is cured and the like) and then the constituent material of the joining layer is packed in the cracks. The present mode includes the crack portion that is packed with the constituent material of the joining layer. Therefore, further higher joining strength is achieved by, in addition to an increase in the contact area relative to the joining layer attained by the fine pores and dimples of the anodic oxide layer, an increase in the contact area relative to the joining layer attained by the crack portion, and the anchor effect attributed to the cracks being deeper than the fine pores and dimples.

As one mode of the reactor of the present invention, a portion of the bottom plate portion may not be provided with the anodic oxide layer and the metal material may be exposed, and the exposed portion may be an attaching place for a ground wire.

In the present mode, since the attaching place for the ground wire is included, grounding work can be performed with ease.

As one mode of the reactor of the present invention, the sidewall portion may be made of an insulating resin.

Since the present mode provides excellent insulation between the coil and the sidewall portion, the distance between the coil and the sidewall portion can be shortened, or the coil and the sidewall portion can be in contact with each other, and a reduction in size of the reactor can be achieved. Further, in the present mode, since the sidewall portion is made of resin which is lightweight as compared to metal, a reduction in weight of the reactor can be achieved.

As one mode of the reactor of the present invention, the total thickness of the joining layer may be 2 mm or less.

In the present mode, since the joining layer is thin, the distance between the coil and the bottom plate portion is very short, and the heat of the coil can be efficiently transferred to the installation target via the bottom plate portion. Thus, an excellent heat dissipating characteristic is exhibited. The thinner the thickness of the joining layer, the greater the heat dissipating characteristic. Accordingly, the joining layer can be 1 mm or less, and furthermore, it can be 0.5 mm or less.

The reactor of the present invention can be suitably used as a constituent element of a converter. A converter of the present invention may include a switching element, a driver circuit that controls the operation of the switching element, and a reactor that smoothes the switching operation. An input voltage may be converted by the operation of the switching element, and the reactor may be the reactor of the present invention. The converter of the present invention can be suitably used as a constituent element of a power converter apparatus. A power converter apparatus of the present invention may include a converter that converts an input voltage, and an inverter that is connected to the converter to interconvert direct current and alternating current. A load may be driven by power converted by the inverter. The converter may be the converter of the present invention.

Since the converter of the present invention and the power converter apparatus of the present invention includes the reactor of the present invention that is excellent in assemblability, adhesion between the coil and the case, and the heat dissipating characteristic, they are excellent in productivity and the heat dissipating characteristic, and each can be preferably used as an in-vehicle component or the like.

### Advantageous Effects of Invention

The reactor of the present invention exhibits high joining strength between the coil and the case, and has an excellent heat dissipating characteristic.

### BRIEF DESCRIPTION OF DRAWINGS

FIG. 1 is a schematic perspective view showing a reactor according to a first embodiment.

FIG. 2 is an exploded perspective view schematically showing the reactor according to the first embodiment.

FIG. 3 is an exploded perspective view schematically showing a combined product made up of a coil and a magnetic core included in the reactor according to the first embodiment.

FIG. 4 is a cross-sectional view of the reactor according to the first embodiment taken along (IV)-(IV) in FIG. 1, in which (A) shows the entire reactor, and (B) and (C) are each an enlarged view showing the area around a joining layer.

FIG. 5 shows photomicrographs of the surface of test pieces used in Test Example 1, in which (A) shows a test piece used as Sample No. 1-2 which has been subjected to surface roughening treatment (anodic oxidation treatment) and (B) shows a test piece used as Sample No. 100 which remains as a rolled member.

FIG. 6 (A) is a photomicrograph of the surface of the test piece being Sample No. 1-2 used in Test Example 1, and (B) is an enlarged view of a crack part.

FIG. 7 (A) is a photomicrograph of a cross section of the area around the boundary between the joining layer and a bottom plate portion in the reactor tentatively produced in Test Example 2, in which (B) is an enlarged view of a crack part inside a quadrangular frame formed by a white dashed line in (A).

FIG. 8 is a schematic configuration diagram schematically showing a power supply system of a hybrid vehicle.

FIG. 9 is a schematic circuit diagram showing an exemplary power converter apparatus of the present invention that includes the converter of the present invention.

### DESCRIPTION OF EMBODIMENTS

In the following, with reference to drawings, a description will be given of a reactor according to embodiments. Throughout the drawings, identical reference signs denote identically named elements. Note that, in the following description, the side becoming the installed side when the reactor is installed is the bottom side, and the side opposite thereto is the top side.

### First Embodiment

<<Overall Structure of Reactor>>

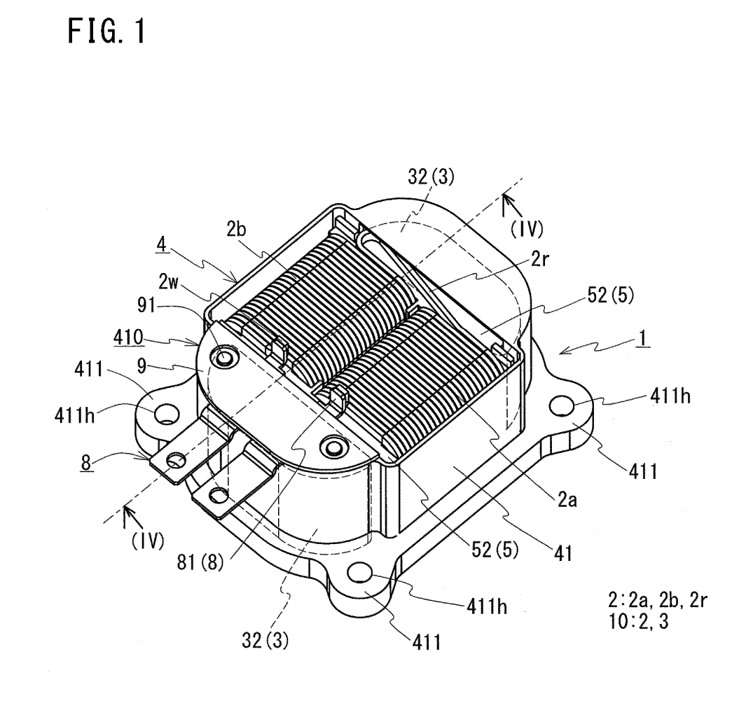

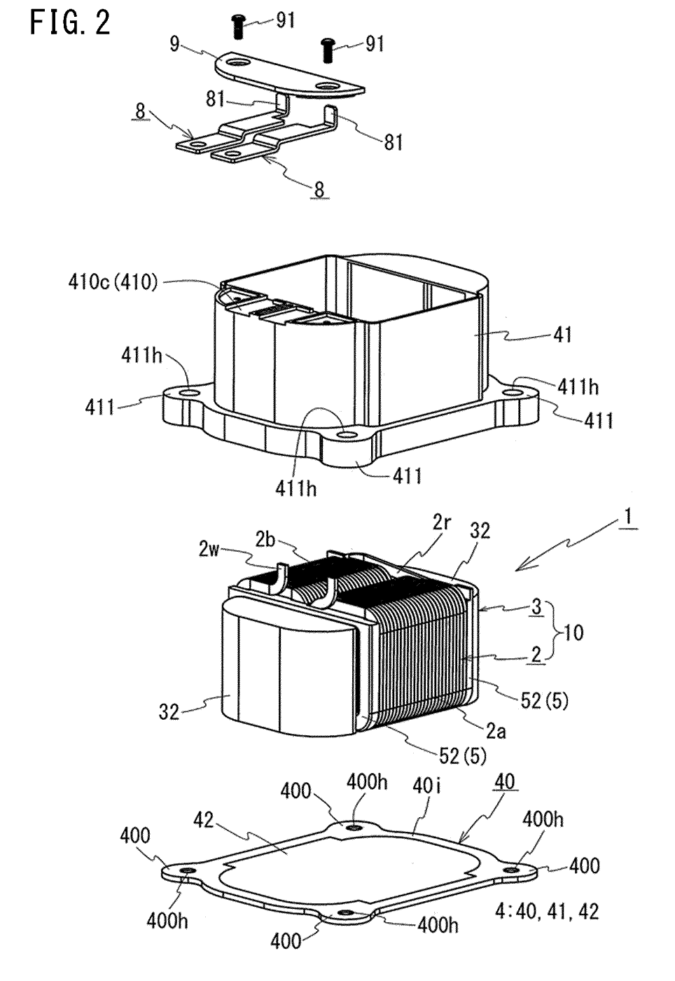

With reference to FIGS. 1 to 4, a description will be given of a reactor 1 according to the first embodiment. The reactor 1 includes a coil 2, a magnetic core 3 where the coil 2 is disposed, and a case 4 that stores a combined product 10 made up of the coil 2 and the magnetic core 3. The case 4 is a box-like element that includes a bottom plate portion 40 (FIG. 2) and a sidewall portion 41 standing from the bottom plate portion 40, and that has its side opposing to the bottom plate portion 40 opened. The reactor 1 is characterized in that (1) the bottom plate portion 40 and the sidewall portion 41 forming the case 4 are not integrally molded but are independent separate members, (2) the bottom plate portion 40 is made of a metal material, and includes a joining layer 42 (FIG. 2) at its inner face 40i (FIG. 2) for fixing the coil 2, and (3) the region where the joining layer 42 is provided in the bottom plate portion 40 has been subjected to surface roughening treatment. In the following, the structures will be described in more detail.

[Coil]

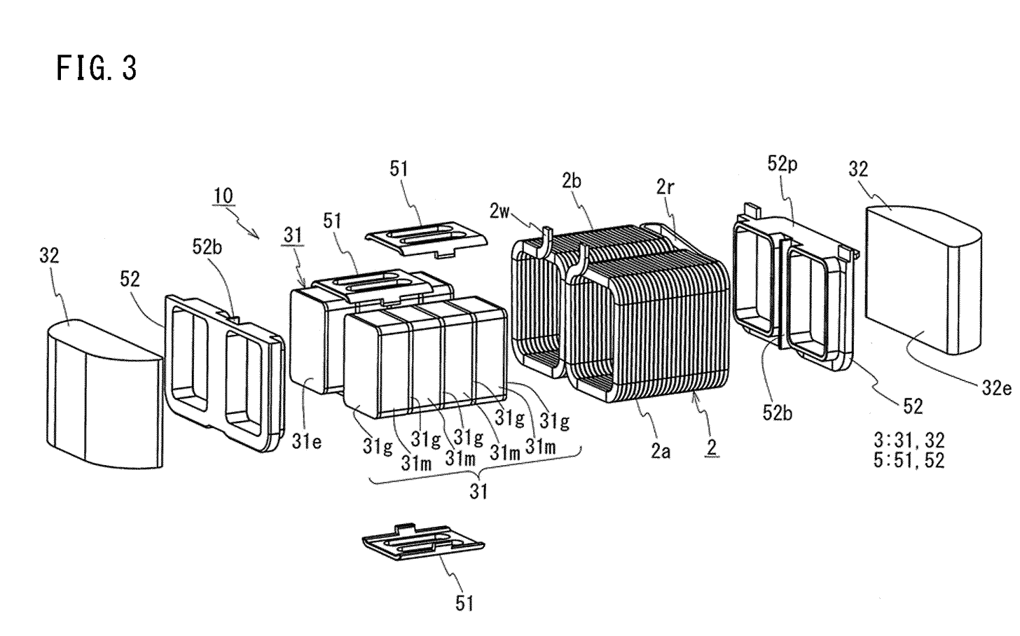

The coil 2 is described mainly with reference to FIGS. 2 and 3. The coil 2 includes a pair of coil elements 2a and 2b formed by one spirally wound wire 2w which is continuous and has no joining portion, and a coil coupling portion 2r that couples the coil elements 2a and 2b. The coil elements 2a and 2b are each a hollow sleeve-like element of identical number of turns, and are paralleled (juxtaposed) such that their respective axial directions are parallel to each other. On other end side (the right side in FIG. 3) of the coil 2, part of the wire 2w is bent in a U-shape, to form the coil coupling portion 2r. By this structure, the winding direction is identical between the coil elements 2a and 2b.

Note that, the coil elements may be formed by separate wires. One end portions of the coil elements may be joined to each other by welding, soldering, fixation under pressure or the like to form the coil.

As the wire 2w, a coated wire including a conductor made of a conductive material such as copper, aluminum, or alloy thereof may be preferably used. The conductor is provided with an insulating coat made of an insulating material at its outer circumference. The conductor is representatively a rectangular wire. The conductor may be of a variety of shape, e.g., having a circular, elliptic, or polygonal cross-section. The rectangular wire has the following advantages: (1) high space factor; (2) ease of securing great contact area relative to the joining layer 42 included in the bottom plate portion 40, a description of which joining layer 42 will be given later; and (3) ease of securing a great contact area relative to terminal fittings 8, whose description will be given later. Herein, what is used is a coated rectangular wire whose conductor is a copper-made rectangular wire and whose insulating coat is enamel (representatively, polyamide-imide). The coil elements 2a and 2b are each an edgewise coil formed by the coated rectangular wire wound edgewise. Further, though the end face shape of the coil elements 2a and 2b is a rounded rectangle herein, it can be changed as appropriate, such as a circle.

The opposite end portions of the wire 2w forming the coil 2 are drawn out as appropriate from the turn forming portion from one end side of the coil 2 (the left side in FIG. 3). Representatively, they are led out to the outside of the case 4 (FIG. 1). At the opposite end portions of the wire 2w, the insulating coat is peeled off and the conductor portion is exposed. Then, one end portions 81 of the terminal fittings 8 made of a conductive material such as copper, aluminum, or alloy thereof are connected to the exposed conductor portions of the wire 2w by soldering, welding, fixation under pressure or the like. Via the terminal fittings 8, an external apparatus (not shown) such as a power supply that supplies the coil 2 with power is connected. Note that, the shape of the terminal fittings 8 shown in FIG. 2 are merely an example, and the shape of the one end portions 81 can be changed as appropriate, such as U-shaped instead of flat plate-like.

[Magnetic Core]

A description will be given of the magnetic core 3 with reference to FIG. 3. The magnetic core 3 includes a pair of inner core portions 31 respectively covered by the coil elements 2a and 2b, and a pair of outer core portions 32 at which the coil 2 is not disposed and exposed outside the coil 2. The inner core portions 31 are each a columnar element (herein, in a shape of rounded rectangular parallelepiped) whose outer shape conforms to the inner circumferential shape of the coil element 2a or 2b. The outer core portions 32 are each a columnar element having a pair of trapezoidal faces. The magnetic core 3 is annularly formed by the outer core portions 32 being disposed to clamp a pair of inner core portions 31 which are disposed as being away from each other, and by end faces 31e of the inner core portions 31 and inner end faces 32e of the outer core portions 32 being brought into contact with each other. The inner core portions 31 and the outer core portions 32 form a closed magnetic path when the coil 2 is energized.

The inner core portions 31 are each a lamination product formed by alternately stacked core pieces 31m made of a magnetic material and gap members 31g representatively made of a non-magnetic material. The outer core portions 32 are core pieces made of a magnetic material.

Each core piece may be a molded product using magnetic powder, or a lamination product formed by a plurality of magnetic thin plates (e.g., electromagnetic steel sheets) having insulating coat being stacked. The molded product may be, for example, iron group metal, iron alloy such as Fe—Si, Fe—Si—Al, steel, a powder magnetic core using powder of a soft magnetic material such as rare-earth metal or an amorphous magnetic element, a sintered product obtained by sintering the above-noted powder having been subjected to press molding, and a hardened mold product (a composite material) obtained by subjecting a mixture of the above-noted powder and resin to injection molding or cast molding. In addition, each core piece may be a ferrite core being a sintered product of metal oxide. With a molded product, any core piece or a magnetic core of a complicated three-dimensional shape can be formed with ease.

The powder magnetic core can be representatively manufactured by: molding a product from coated powder made of the above-noted soft magnetic material, each particle of the powder including an insulating coat (silicone resin, phosphate or the like) on its surface; and subjecting the product to heat treatment (which is preferably performed at the temperature equal to or less than the heat resistant temperature of the insulating coat). Herein, each core piece is a powder magnetic core of soft magnetic powder containing iron, such as iron or steel.

The gap members 31g are each a plate-like member that is disposed between the core pieces for adjusting inductance. The gap members 31g are made of a material lower in permeability than the core pieces. The representative constituent material may be a non-magnetic material such as alumina, glass epoxy resin, or unsaturated polyester. Alternatively, when the gap members are made of a mixture material in which magnetic powder (e.g., ferrite, Fe, Fe—Si, Sendust or the like) is dispersed in a non-magnetic material such as ceramic or phenolic resin, any leakage flux at the gap portion can be suppressed. It is also possible to employ air gaps. Depending on the material of the core pieces, the gapless mode in which no gap member is included can be employed. The number of the core pieces or the gap members can be selected as appropriate such that the reactor 1 achieves the desired inductance. Further, the shape of each core piece or gap member can be selected as appropriate.

In order to integrate the core pieces, or to integrate the core pieces 31m and the gap members 31g, for example, an adhesive agent or an adhesive tape can be used. For example, it is possible to use an adhesive tape for forming the inner core portions 31, and to join the inner core portions 31 and the outer core portions 32 to each other using an adhesive agent.

Alternatively, the inner core portions 31 can be formed using an insulating tubing such as a heat shrink tubing or a cold shrink tubing. In this situation, the insulating tubing functions as an insulating member between the coil elements 2a and 2b and the inner core portions 31.

In addition, in connection with the present exemplary magnetic core 3, the faces of the inner core portions 31 on the installed side (the bottom faces in FIG. 3) and the faces of the outer core portions 32 on the installed side (the bottom faces in FIG. 3, hereinafter referred to as the core installation faces) are not flush with each other. The core installation faces of the outer core portions 32 project further than the inner core portions 31 and are flush with the face of the coil 2 on the installed side (the bottom face in FIG. 3, hereinafter referred to as the coil installation face). Accordingly, the face on the installed side of the combined product 10, which is made up of the coil 2 and the magnetic core 3, is formed by the coil installation faces of the coil elements 2a and 2b and the core installation faces of the outer core portions 32, and both the coil 2 and the magnetic core 3 are brought into contact with the joining layer 42 (FIG. 2) whose description will follow. Since the face of the combined product 10 on the installed side is formed by both of the coil 2 and the magnetic core 3, the contact area relative to the bottom plate portion 40 (FIG. 2) is sufficiently great. Thus, the reactor 1 also exhibits excellent stability when installed. Further, since each core piece is formed by the powder magnetic core, any portion in the outer core portions 32 that projects further than the inner core portions 31 can be used as a passage of a magnetic flux.

[Insulator]

The present exemplary reactor 1 further includes an insulator 5 that is interposed between the coil 2 and the magnetic core 3. Since the insulator 5 is included, the reactor 1 can enhance insulation between the coil 2 and the magnetic core 3.

As shown in FIG. 3, the insulator 5 includes circumferential wall portions 51 that are respectively disposed outside the outer circumference of the inner core portions 31, and a pair of frame plate portions 52 interposed between the end faces of the coil elements 2a and 2b and the inner end faces 32e of the outer core portions 32.

The circumferential wall portions 51 are members insulating between the coil elements 2a and 2b and the inner core portions 31. Each circumferential wall portion 51 is made of a pair of divisional pieces whose cross-section is ]-shaped. The divisional pieces are divided in the direction (the top-bottom direction in FIG. 3) perpendicular to the axial direction of the corresponding inner core portion 31, and can be easily disposed at the outer circumference of the inner core portions 31. Herein, when the circumferential wall portions 51 are disposed on the inner core portions 31, the outer circumferential face of each of the inner core portions 31 may not be entirely covered and partially exposed. The divisional pieces may be formed to become a sleeve-like element covering the entire circumference of the corresponding inner core portion 31 when the divisional pieces are combined. The shape thereof can be changed as appropriate.

The frame plate portions 52 are each a B-shaped flat plate member having a pair of opening portions (through holes) into which the inner core portions 31 can be respectively inserted. Herein, the frame plate portions 52 each have a partition plate 52b between the opening portions. When the frame plate portions 52 are assembled to the coil 2, each partition plate 52b is interposed between the coil elements 2a and 2b, to enhance insulation between the coil elements 2a and 2b. Further, one (the right one in FIG. 3) frame plate portion 52 has a pedestal 52p on which the coil coupling portion 2r is placed. The pedestal 52p functions to insulate between the coil coupling portion 2r and the outer core portion 32.

The shape of the insulator can be selected as appropriate. As described above, the circumferential wall portions 51 and the frame plate portions 52 may be separate members. Alternatively, sleeve pieces forming the circumferential wall portions may be integrally molded with the frame plate portions. In this mode, a pair of divisional pieces (forming the forgoing integrally molded product) that can be divided in the axial direction of the coil 2 is provided. When the divisional pieces each have an engaging portion for engaging with each other, relative positioning can be carried out with ease. Alternatively, the circumferential wall portions 51 may be dispensed with while solely the frame plate portions 52 may be employed. Then, another insulating coat layer may be provided around the outer circumference of the inner core portions 31 (for example, by wrapping the insulating tubing, the insulating tape, or the insulating paper).

The insulator 5 may be made of an insulating material such as polyphenylene sulfide (PPS) resin, polytetrafluoroethylene (PTFE) resin, polybutylene terephthalate (PBT) resin, and liquid crystal polymer (LCP). In forming the insulator 5, the molding method such as an injection molding can be suitably used.

[Case]

A description will be given of the case 4 with reference to FIG. 2. The case 4 includes the flat plate-like bottom plate portion 40 and the frame-like sidewall portion 41 that stands from the bottom plate portion 40. As described above, the bottom plate portion 40 and the sidewall portion 41 are separate members.

(Bottom Plate Portion)

The bottom plate portion 40 is representatively disposed such that its one face is in contact with the installation target such as a cooling base when the reactor 1 is installed on the installation target. The one face serves as the cooling face. The bottom plate portion 40 should be large enough for the combined product 10 made up of the coil 2 and the magnetic core 3 to be placed thereon and for the sidewall portion 41 to be attached thereto. The outer shape (the planar shape) of the bottom plate portion 40 can be selected as appropriate. Herein, the bottom plate portion 40 is a quadrangular plate, with attaching portions 400 respectively projecting from the four corners.

The attaching portions 400 are each provided with a bolt hole 400h into which a bolt (not shown) for fixing the case 4 to the installation target such as a cooling base is inserted. Herein, the bolt holes 400h are provided so as to be continuous to bolt holes 411h of the sidewall portion 41, whose description will follow. The bolt holes 400h and 411h may be through holes not being threaded or screw holes being threaded, and the number of holes and the like can be selected as appropriate. The reactor 1 is fixed by the bolts (not shown) disposed at the bolt holes 400h and 411h, with the bottom plate portion 40 being in contact with the installation target.

(Sidewall Portion)

The sidewall portion 41 is a quadrangular frame-like element. When the case 4 is assembled having one opening portion closed by the bottom plate portion 40, the sidewall portion 41 is disposed to surround the combined product 10 made up of the coil 2 and the magnetic core 3, and other opening portion is open. Herein, in connection with the outer shape of the sidewall portion 41, the opening-side region (the upper region in FIG. 2) is in the shape conforming to the outer circumferential face of the combined product 10 (i.e., the shape formed by a combination of flat surfaces and curved surfaces). The region becoming the installed side when the reactor 1 is installed on the installation target (the bottom region in FIG. 2) is in a stepped shape. That is, the bottom region of the sidewall portion 41 projects outward than the opening-side region, conforming to the outer shape of the bottom plate portion 40. The shape of the sidewall portion 41 can be changed as appropriate. For example, it can be a simple quadrangular frame, or the quadrangular frame may be provided with attaching portions 411.

Herein, in the opening-side region of the sidewall portion 41, overhanging portions are provided so as to respectively cover the trapezoidal faces of the outer core portions 32 of the combined product 10. With the overhanging portions, as shown in FIG. 1, the combined product 10 stored in the case 4 has its coil 2 exposed, while the magnetic core 3 is substantially covered by the constituent material of the case 4. Since the overhanging portions are included, the various effects such as follows can be obtained: (1) an improvement in vibration-proofing characteristic; (2) an improvement in rigidity of the case 4 (the sidewall portion 41); (3) protection from the external environment or mechanical protection of the magnetic core 3 (the outer core portions 32); (4) prevention of the combined product 10 from coming off (the stopper function); and (5) use as a terminal block 410 whose description will follow. When one of or both of the overhanging portions are dispensed with such that the coil 2 and the trapezoidal face of one of or both of the outer core portions 32 are exposed, the shape of the sidewall portion 41 can be simplified.

Herein, one (the left one in FIG. 2) overhanging portion is used as the terminal block 410. The overhanging portion includes concave grooves 410c into which a pair of terminal fittings 8 are fitted, the end portions of the wire 2w being respectively connected to the terminal fittings 8. Disposing the terminal fittings 8 in the concave grooves 410c, covering part (the middle portion) of the terminal fittings 8 by a terminal fixing member 9, and fastening the terminal fixing member 9 by bolts 91, the terminal fittings 8 are fixed to the sidewall portion 41. Thus, the terminal block 410 can be formed.

Note that, in the situation where the sidewall portion 41 is formed by an insulating resin, the sidewall portion, the terminal fittings 8, and the terminal block can be integrated if the terminal fittings 8 are formed by insert molding in place of using the terminal fixing member 9 and the bolts 91. Since this mode requires fewer components and assembly steps, excellent productivity of the reactor is exhibited.

The region of the sidewall portion 41 on the installed side includes, similarly to the bottom plate portion 40, the attaching portions 411 respectively projecting from the four corners. The attaching portions 411 are each provided with the bolt hole 411h, to form the attaching place. When the case 4 is formed by a combination of the bottom plate portion 40 and the sidewall portion 41, the attaching portions 400 of the bottom plate portion 40 and the attaching portions 411 of the sidewall portion 41 are overlaid on each other. The bolt holes 411h may be solely formed by the constituent material of the sidewall portion 41. Alternatively, they may be formed by disposing tubular elements made of other material. For example, in the situation where the sidewall portion 41 is made of resin, when metal pipes made of metals such as brass, steel, or stainless steel are used as the tubular element, excellent strength is exhibited. Thus, creep deformation can be suppressed as compared to the situation where the bolt holes 411h are solely made of resin. Herein, metal pipes are disposed to form the bolt holes 411h.

Herein, though both the bottom plate portion 40 and the sidewall portion 41 include the attaching portions 400 and 411, solely the bottom plate portion 40 may include the attaching portions 400, or solely the sidewall portion 41 may include the attaching portions 411. In the former mode, the attaching portions 400 of the bottom plate portion 40 are formed such that the attaching portions 400 project outward than the outer shape of the sidewall portion. In the latter mode, the bottom plate portion is formed, for example, as a quadrangular plate, and the outer shape of the sidewall portion 41 is formed such that the attaching portions 411 of the sidewall portion 41 project outward than the outer shape of the bottom plate portion.

(Material)

Since the bottom plate portion 40 and the sidewall portion 41 are separate members, they can be made of materials of different types. In the present invention, the bottom plate portion 40 is made of a material with high thermal conductivity such as a metal material, such that the bottom plate portion 40 can be used as a heat dissipation path.

Specific metal may include, for example, aluminum (thermal conductivity: 237 W/m·K) and alloy thereof, magnesium (156 W/m·K) and alloy thereof, copper (398 W/m·K) and alloy thereof, silver (427 W/m·K) and alloy thereof, titanium (21.9 W/m·K) and alloy thereof, iron (80 W/m·K) and austenitic stainless steel (e.g., SUS 304: 16.7 W/m·K). In particular, aluminum and alloy thereof are lightweight, and furthermore, exhibit excellent corrosion resistance. Magnesium and alloy thereof are further lightweight, and furthermore, exhibit an excellent vibration-proofing characteristic. Therefore, they can be suitably used for an in-vehicle component. Titanium and alloy thereof are relatively lightweight and exhibit excellent strength and corrosion resistance. Further, with aluminum, magnesium, titanium and alloy thereof, anodic oxidation treatment can be employed as the surface roughening treatment whose description will follow, and hence excellent workability of surface roughening treatment is exhibited. Copper, silver and alloy thereof exhibit excellent thermal conductivity, and a reactor with an excellent heat dissipating characteristic can be obtained. Iron and alloy thereof exhibit excellent strength and corrosion resistance. In particular, when the bottom plate portion 40 is made of a non-magnetic metal such as aluminum or magnesium, the coil 2 will not be easily magnetically influenced even when the coil 2 is disposed in close proximity to the bottom plate portion 40.

The bottom plate portion 40 can be manufactured into any desired shape by casting such as die casting. Alternatively, the bottom plate portion 40 can be manufactured by subjecting a rolled member, i.e., a rolled casting material, to press working (representatively, punching) or cutting, such that the rolled member assumes any desired shape.

The constituent material of the sidewall portion 41 may be, for example, a material that exhibits excellent electrical insulating performance and heat resistance. The material may be, for example, an insulating resin. Specifically, it may be thermoplastic resin such as acrylonitrile butadiene styrene (ABS) resin, PBT resin, PPS resin, polypropylene (PP), polystyrene (PS), polyethylene (PE), polyethylene terephthalate (PET), polycarbonate (PC), polyacetal (POM), acrylic resin, Nylon 6, Nylon 66, LCP, and urethane resin. Further, using a resin that contains at least one type of ceramic selected from silicon nitride, aluminum oxide (alumina), aluminum nitride, boron nitride, mullite, and silicon carbide, excellent insulation is exhibited, and the heat dissipating characteristic can also be enhanced.

Alternatively, the sidewall portion 41 may be made of the above-noted metal material (particularly a non-magnetic metal). When the sidewall portion 41 is also made of a metal material, the heat dissipating characteristic and the strength can be further enhanced.

Herein, the bottom plate portion 40 is made of aluminum alloy, and the sidewall portion 41 is made of PPS resin. Accordingly, in connection with the reactor 1, the bottom plate portion 40 is sufficiently high than the sidewall portion 41 in the thermal conductivity, and an excellent heat dissipating characteristic is exhibited. Further, herein, the coil 2 and the sidewall portion 41 are disposed in close proximity to each other. That is, the interval between the outer circumferential face of the coil 2 and the inner circumferential face of the sidewall portion 41 is very narrow, i.e., about 0 mm to 1.0 mm. This also contributes to an excellent heat dissipating characteristic. Though the coil 2 and the sidewall portion 41 are disposed in close proximity to each other, since the sidewall portion 41 is made of an insulating resin as described above, excellent insulation is exhibited.

(Coupling Method)

In integrally connecting the bottom plate portion 40 and the sidewall portion 41 to each other, various fixing members can be used. The fixing members may be, for example, fastening members such as an adhesive agent or bolts. Herein, bolt holes (not shown) are formed at the bottom plate portion 40 and the sidewall portion 41 and bolts (not shown) are employed as the fixing members. Thus, the bottom plate portion 40 and the sidewall portion 41 are integrated by the bolts being screwed into the bolt holes.

(Surface Roughening Treatment)

One of the characteristics of the present invention lies in that surface roughening treatment is provided to at least part of the surface of the bottom plate portion 40 made of a metal material, specifically, at the region where the joining layer 42 is provided. A description of the joining layer 42 will be given later.

The surface roughening treatment is treatment for forming minor unevenness in order to increase the contact area between the bottom plate portion 40 and the joining layer 42. Specific treatment may include (1) anodic oxidation treatment represented by aluminum anodizing, (2) acicular plating, (3) molecular junction compound implanting, (4) groove forming work by laser, (5) nano-order dimple formation, (6) etching process, (7) sand blasting or shot blasting, (8) filing, (9) and delustering treatment by sodium hydroxide. Exemplary minor unevenness may have, for example, surface roughness in Ra of 10 μm or less.

The treatment (2) is for forming acicular metal plating (e.g., nickel plating) whose diameter is φ0.1 μm to 0.2 μm and length is 2 μm to 3 μm on a metal base (herein the bottom plate portion 40, which holds true for any description relating to the surface roughening treatment hereinafter). These acicular products form minor unevenness. The treatment (3) is for applying a reactive functional group (—OH) to the metal base by any known scheme, and thereafter implanting a molecular junction compound to the metal base. By the molecular junction compound being present at the surface of the metal base, minor unevenness is formed. The molecular junction compound exhibits excellent adhesion between the metal base and resin (herein the joining layer 42, which holds true for any description in this section). The treatment (4) is for scanning YAG laser on the surface of the metal base as appropriate (e.g., scanning in a grid-like manner), to form grooves each having, for example, a width of about 50 μm and a depth of about 50 μm to 100 μm. The width, depth, and shape of the groove can be selected as appropriate such that desired unevenness is formed. The treatment (5) is for immersing the metal base in a known special treatment solution to form very minor dimples, whereby very minor unevenness that exhibits excellent adhesion to the resin can be formed. The treatment (6) is for immersing and eroding the metal base in the etching treatment solution (an acid solution or an alkaline solution) to form unevenness. The unevenness can be formed at only a desired region using masking. Further, by adjusting the concentration, type, immersion time of the etching solution, the size of unevenness can be changed. The treatment (7) is for allowing particles of appropriate material and size to collide against the metal base, to form the unevenness. The treatment (8) is for grinding the surface of the metal base using a known file, to form unevenness. The treatment (9) is for immersing the metal base in the sodium hydroxide solution, to increase coarseness of the surface of the metal base. Thus, unevenness is formed. Any known delustering treatment can be used. In the treatments (2) to (9), known conditions or commercially available treatment solutions or schemes that are used to the metal material described above can be used as appropriate.

Further, (1) anodic oxidation treatment can be carried out with reference to, for example, Annex 2 (Informative) of JIS H 8601 (1999) as to aluminum and alloy thereof; with reference to JIS H 8651 (2011) as to magnesium and alloy thereof; and with reference to JIS W 1108 (2000) as to titanium and alloy thereof. In each situation, any known conditions can be employed. Though it depends on conditions, anodic oxidation treatment can form an anodic oxide layer that includes: a dense layer referred to as a barrier layer on the metal base side; and a porous layer having a plurality of fine pores (representatively, having a diameter of about 300 nm to 700 nm) on the dense layer. With the fine pores and dimples having a diameter of about 3 μm to 400 μm and being present on the surface of the anodic oxide layer, the unevenness can be formed.

The anodic oxidation treatment has the following advantages: (1) a plurality of materials or a material of great size can be subjected to surface roughening treatment at once; (2) the thickness of the anodic oxide layer or the state of the unevenness (the depth or number of fine pores or dimples) can be easily adjusted by conditions; (3) since a great amount of OH group is present on the surface, hydrogen bonds occur by intermolecular force and, hence, excellent adhesion to the resin is exhibited; and (4) insulation can be enhanced by the anodic oxide layer.

Though the thickness of the anodic oxide layer can be selected as appropriate, it is preferably 2 μm or more. Herein, the fine pores normally do not reach the metal base because of the presence of the aforementioned barrier layer. However, when the thickness of the anodic oxide layer is 2 μm or more, in particular greater than 3 μm, the depth of the fine pore becomes fully deep, whereby the contact area relative to the constituent material of the joining layer 42 can be increased. Accordingly, by the aforementioned dimples and these fine pores, adhesion between the anodic oxide layer and the joining layer 42 can be enhanced, whereby the joining strength between the coil 2 and the bottom plate portion 40 can be increased.

Further, as a result of the study of the inventors of the present invention, it was found that, when the anodic oxide layer is increased in thickness to some degree, cracks generate in a mesh-like manner by the later thermal hysteresis of the anodic oxide layer. Particularly, deep cracks that reach the metal base generate. The cracks are packed with the (softened) constituent material of the joining layer (representatively, resin such as an adhesive agent). In the mode including the anodic oxide layer whose cracks are packed with the constituent material of the joining layer, the joining strength of the coil and the bottom plate portion increases. From this viewpoint also, the anodic oxide layer is preferably 9 μm or more, more preferably 12 μm or more. However, when the thickness of the anodic oxide layer is excessively great, a reduction in the heat dissipating characteristic is invited. Therefore, the thickness is preferably 20 μm or less, further preferably 15 μm or less. By the anodic oxide layer having a thickness of 20 μm or less, the total thickness including that of the joining layer 42, whose description will follow, can be set to 2 mm or less, further to 1.5 mm or less, and particularly to 1 mm or less. The thickness of the anodic oxide layer, the number and depth of fine pores, and the number, depth and size (diameter) of dimples can be changed by adjusting the type of treatment solution, the immersion time, the electrolysis voltage and the like. Known conditions can be employed as appropriate.

Despite the cracks not reaching the metal base, an increase in the contact area relative to the constituent material of the joining layer can be achieved because the cracks are present in the anodic oxide layer in addition to the fine pores and dimples. As the depth of the cracks is greater, the anchor effect achieved by the constituent material of the joining layer packed in the cracks becomes stronger. The presence or absence of the cracks and the depth of the cracks can be checked by observing the cross-section of the bottom plate portion using an optical microscope or a scanning electron microscope (SEM). The length of the cracks can be checked by removing the joining layer and observing the surface of the bottom plate portion using an optical microscope or an SEM. The depth of the cracks is preferably greater than the depth of the fine pores, and preferably as great as the thickness of the anodic oxide layer, that is, reaching the metal base. Further, it is considered that, as the number of the cracks or the length of the cracks is greater, the contact area can further be increased. The number, length, depth of the cracks change depending on the thermal hysteresis after the anodic oxide layer is formed. When the heat treatment is performed after the anodic oxide layer is formed, the number of the cracks tends to be increased in the following conditions, for example: when the heating temperature is raised; when the holding time is increased; and when the anodic oxide layer is rapidly cooled from the heating temperature in the cooling process. Heat treatment for forming the cracks may be separately performed after the bottom plate portion 40 is subjected to anodic oxidation treatment. However, in the mode in which the joining layer 42 is formed by a material requiring thermal curing, and in which a step of curing the joining layer 42 and a sealing resin being a material requiring thermal curing are involved, the step of curing the sealing resin can serve also as the heat treatment for forming the cracks. As in Test Example which will be described later, when the anodic oxide layer being thick to some degree is formed, the cracks can be sufficiently formed by the curing step described above.

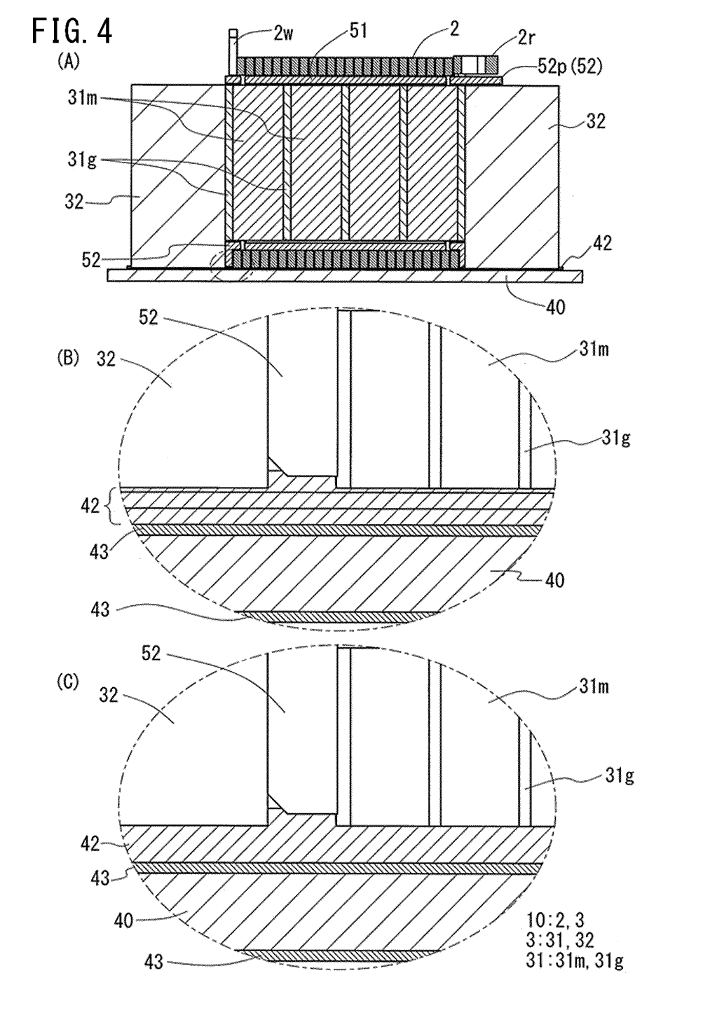

In the bottom plate portion 40, the region subjected to surface roughening treatment can be selected as appropriate, so long as it includes the region where the joining layer 42 is provided. For example, the entire inner face 40i of the bottom plate portion 40, the inner face 40i and the entire side face of the bottom plate portion 40, the inner face 40i and outer surface of the bottom plate portion 40, or the entire surface of the bottom plate portion 40 can be subjected to the surface roughening treatment. FIG. 4 illustrates the mode in which the anodic oxide layer 43 is provided to the entire bottom plate portion 40. In FIG. 4 (A), for the sake of convenience, the sidewall portion 41, the terminal fittings 8 and the like are not shown. FIGS. 4 (B) and 4 (C) each show the region in the dashed-dotted circle in FIG. 4 (A) in an enlarged manner, with the joining layer 42 being enhanced (shown thicker) for the sake of convenience.

When the entire bottom plate portion 40 is subjected to surface roughening treatment, out of surface roughening treatments, any treatment that involves work of immersing the bottom plate portion 40 into a treatment solution (e.g., anodic oxidation treatment or etching process) can be carried out without the necessity of masking. Accordingly, the work of immersing the bottom plate portion 40 into a treatment solution or the like can be carried out with ease, and excellent productivity is exhibited. Out of surface roughening treatments, with any treatment that involves mechanical works (works in which laser or sand blasting is used), the metal material is exposed even after the surface roughening treatment is performed. Accordingly, attachment of the ground wire can be performed with ease. In attaching the ground wire, native oxide is removed as appropriate. When only part of the bottom plate portion 40 is subjected to surface roughening treatment, depending on the type of the surface roughening treatment (e.g., laser work), a reduction in processing time is achieved and hence excellent productivity is exhibited.

When the surface roughening treatment is performed as a process of forming coating that exhibits an excellent insulating performance, such as anodic oxidation treatment, it becomes possible to achieve the mode in which any part in the bottom plate portion 40 except for the formation region of the joining layer 42 is not subjected to the surface roughening treatment (not provided with the coating), and the exposed portion where the metal forming the bottom plate portion 40 is exposed is provided. When this exposed place is used as the attaching place of the ground wire, for example, the grounding work can be carried out with ease. Further, for example, when the outer surface of the bottom plate portion 40 that is brought into contact with the installation target does not include the anodic oxide layer and the metal material is exposed, the heat dissipating characteristic is expected to be improved.

(Joining Layer)

The reactor 1 includes the joining layer 42 (FIGS. 2 and 4) in the region having been subjected to the above-described surface roughening treatment in the inner face 40i of the bottom plate portion 40. The joining layer 42 is brought into contact with the coil installation face of the coil 2 for fixing the coil 2 to the bottom plate portion 40.

The constituent material of the joining layer 42 may be a material that can fix the coil 2 to the bottom plate portion 40, representatively, resin such as an adhesive agent. The joining layer 42 is easily formed into a desired shape, for example, by applying an adhesive agent to the bottom plate portion 40 that has been subjected to surface roughening treatment described above, or by using screen printing. Alternatively, using a sheet-like adhesive agent cut into a desired shape, the joining layer 42 can be formed more easily. The screen printing or the sheet-like adhesive agent can form a precise shape.

The adhesive layer 42 can be formed to have a single-layer structure shown in FIG. 4 (C), or to have a multilayer structure (herein, a three-layer structure) shown in FIG. 4 (B). In the single-layer structure, the joining layer 42 can be very easily formed when a sheet-like adhesive agent is used. In the multilayer structure, the layers may be made of a constituent material of an identical type, or may be made of constituent materials of different types. For example, a multilayer structure that includes a layer exhibiting an excellent electrical insulating performance, a layer exhibiting an excellent heat dissipating characteristic, and a layer exhibiting excellent adhesion can be employed. The materials are selected such that layers of desired characteristics are formed, respectively. The multilayer structure can be formed by a plurality of layers of screen printing, or by a plurality of layers of sheet-like adhesive agent, for example.

The constituent material of the joining layer 42 is preferably an insulating resin, particularly an insulating adhesive agent (including a sheet-like adhesive agent). The insulating resin may be, for example, epoxy resin or acrylic resin. Further, using an insulating resin containing a filler made of ceramic such as silicon nitride or alumina, the joining layer 42 with excellent heat dissipating characteristic and electrical insulating performance can be formed.

When the joining layer 42 is made of an insulating material whose thermal conductivity is greater than 2 W/m·K, excellent heat dissipating characteristic and insulating performance can be achieved. As the thermal conductivity is higher, the heat dissipating characteristic can be improved. The joining layer 42 may be made of a material whose thermal conductivity is 3 W/m·K or more, particularly 10 W/m·K or more, further preferably 20 W/m·K or more, and even more preferably 30 W/m·K or more. In the situation where the joining layer 42 is made of a material containing the filler, the material and content of the filler can be adjusted such that a desired thermal conductivity is achieved.

In connection with the thickness of the joining layer 42, whether in a single-layer structure or a multilayer structure, as the thickness (the total thickness for a multilayer structure, the same holds true for the following) is thinner, the interval between the coil 2 and the bottom plate portion 40 can be reduced, and an increase in the heat dissipating characteristic and a reduction in size can be achieved. As the thickness is greater, the coil 2 can be strongly retained, and an improvement of insulation between the coil 2 and the bottom plate portion 40 can be achieved when the joining layer 42 is made of an insulating material. For example, when the joining layer 42 is made of an insulating material, insulation between the coil 2 and the bottom plate portion 40 can be secured even when the thickness of the joining layer 42 is 1 mm or less, or even 0.5 mm or less. Furthermore, such a small thickness enhances the heat dissipating characteristic. Alternatively, in the situation where the joining layer 42 is made of a material having an excellent heat dissipating characteristic, a sufficiently excellent heat dissipating characteristic is exhibited when the thickness of the joining layer 42 is 0.5 mm or more, or even 1 mm or more.

Note that, the thickness of the joining layer 42 described above is the thickness of the joining layer 42 when it is formed. In the state where the combined product 10 made up of the coil 2 and the magnetic core 3 is placed on the joining layer 42, the thickness becomes thinner than that at the time of formation, and in some cases, it becomes about 0.1 mm, for example.

The joining layer 42 shown in FIG. 4 (B) is, for example, a total of three-layer structure including an adhesive agent layer (having a thickness of 0.1 mm) made of an epoxy-base adhesive agent (an insulating adhesive agent), and two heat dissipating layers (each having a thickness of 0.15 mm, the thermal conductivity being 3 W/m·K) made of an epoxy-base adhesive agent (an insulating adhesive agent) containing a filler made of alumina. The total thickness of the joining layer 42 is 0.4 mm. The joining layer 42 shown in FIG. 4 (C) is formed by a sheet-like adhesive agent made of an epoxy-base adhesive agent containing a filler made of alumina, for example (thickness before curing: 0.4 mm, thickness after placement of the combined product 10: 0.1 mm).

So long as the joining layer 42 is large enough for the coil installation face of the coil 2 to be fully brought into contact with, the shape thereof is not particularly limited. Herein, as shown in FIG. 2, the joining layer 42 has a shape that conforms to the shape formed by the coil installation face and the core installation faces of the outer core portions 32. For example, in the situation where an adhesive agent (including a sheet-like adhesive agent) is used also in integrating the bottom plate portion 40 and the sidewall portion 41, when the adhesive agent and the joining layer 42 are made of an identical constituent material and disposed on the bottom plate portion 40 at once, excellent workability is preferably exhibited. That is, an adhesive agent is disposed at the installation region of the coil 2 in the inner face 40i of the bottom plate portion 40 (herein, the installation region of the combined product 10 made up of the coil 2 and the magnetic core 3) and at the installation region of the sidewall portion 41 to form an adhesive agent layer. Then, part of the adhesive agent layer is used as the joining layer 42. This mode can achieve excellent productivity because the step of disposing an adhesive agent and the curing step can be reduced.

In addition to the joining layer 42, for example, an insulating sheet (not shown) may be included. Provision of the insulating sheet can further enhance insulation between the coil 2 and the bottom plate portion 40. Therefore, for example, using an adhesive agent of high adhesive force as the constituent material of the joining layer 42, insulation can be secured by the insulating sheet. The insulating sheet may be made of an insulating resin such as amide-imide resin, polyimide resin, polyester-base resin, or epoxy-base resin, for example. When the insulating sheet is thin, i.e., having a thickness of 0.5 mm or less, more preferably 0.15 mm or less, and particularly preferably 0.1 mm or less, the total thickness of the joining layer 42 and the insulating sheet is small and hence the heat dissipating characteristic between the coil 2 and the bottom plate portion 40 can be preferably enhanced. When the insulating sheet having an adhesive layer on at least one side is used, the insulating sheet can be closely attached to the joining layer 42 or the bottom plate portion 40. When the insulating sheet having an adhesive layer is disposed immediately above the bottom plate portion 40 (i.e., at the region having been subjected to surface roughening treatment), the adhesive layer of the insulating sheet is closely joined to the region having been subjected to surface roughening treatment. When the insulating sheet does not have an adhesive layer, for example, it is possible to employ the mode in which the joining layer 42 is in a multilayer structure, and the insulating sheet is interposed between the layers forming the joining layer 42. In this mode, the joining layer 42 and the insulating sheet made of resin are strongly joined to each other, and the joining layer 42 is strongly joined to the region having been subjected to surface roughening treatment as described above.

[Sealing Resin]

In other possible mode, a sealing resin (not shown) made of an insulating resin may be packed in the case 4. The packing amount of the sealing resin may be selected as appropriate. For example, when the end portions of the wire are exposed outside the sealing resin, the connecting work to the terminal fittings 8 can be carried out with ease. Part of the coil 2 may be exposed outside the sealing resin.

The sealing resin may be, for example, epoxy resin, urethane resin, or silicone resin. Further, employing a sealing resin that contains a filler made of ceramic being excellent in insulating performance and thermal conductivity as described above, insulation and the heat dissipating characteristic can be further improved.

In the mode where the sealing resin is included, in the situation where fastening members such as bolts are used as the fixing member for integrating the bottom plate portion 40 and the sidewall portion 41, provision of a sealing member (not shown) can prevent uncured sealing resin from leaking from any clearance between the bottom plate portion 40 and the sidewall portion 41. When an adhesive agent is used as the fixing member for integration, such a sealing member can be dispensed with because the adhesive agent can seal any clearance between the bottom plate portion 40 and the sidewall portion 41.

<<Manufacture of Reactor>>

The reactor 1 having the structure described above can be manufactured, for example, by the procedures of preparing the combined product, preparing the sidewall portion, and preparing the bottom plate portion (including surface roughening treatment)→disposing the combined product→integrating the bottom plate portion and the sidewall portion (→packing the sealing resin).

[Preparation of Combined Product]

Firstly, a description will be given of the fabrication procedure of the combined product 10 made up of the coil 2 and the magnetic core 3. Specifically, as shown in FIG. 3, the inner core portions 31 are formed by stacking the core pieces 31m and the gap members 31g. The circumferential wall portions 51 of the insulator 5 are disposed at the outer circumference of the inner core portions 31. Then, the inner core portions 31 are inserted into the coil elements 2a and 2b, respectively. Herein, what are used are the inner core portions 31 integrated by an adhesive tape (not shown) being wrapped around the outer circumference of the lamination products of the core pieces 31m and the gap members 31g.

Next, the frame plate portions 52 and the outer core portions 32 are disposed such that the assembled product made up of the coil 2 and the inner core portions 31 is clamped by the frame plate portions 52 of the insulator 5 and the outer core portions 32. At this time, the end faces 31e of the inner core portions 31 are exposed outside the opening portions of the frame plate portions 52, and in contact with the inner end faces 32e of the outer core portions 32. By this procedure, the combined product 10 is obtained.

[Preparation of Sidewall Portion]

The sidewall portion 41 that is formed into a prescribed shape by injection molding or the like is prepared. Herein, as shown in FIG. 2, the terminal fittings 8 and the terminal fixing member 9 are disposed in order in the concave grooves 410c. Then, the bolts 91 are fastened to form the terminal block 410. Thus, the sidewall portion 41 including the terminal block 410 is prepared. The terminal fittings 8 can be fixed to the sidewall portion 41 after the case 4 is assembled. As described above, it is also possible to prepare the sidewall portion being integrated with the terminal fittings 8.

[Preparation of Bottom Plate Portion]

The bottom plate portion 40 is formed by punching a raw-material metal plate (herein, an aluminum alloy plate) into a prescribed shape. In this bottom plate portion 40, at least the region where the joining layer 42 is provided is subjected to surface roughening treatment. Herein, the entire bottom plate portion 40 is subjected to aluminum anodizing (anodic oxidation treatment). It is also possible that the raw-material metal plate is previously subjected to surface roughening treatment, and thereafter punched into a prescribed shape.

The joining layer 42 of a prescribed shape is formed at one face of the bottom plate portion 40 having been subjected to the anodic oxidation treatment. Herein, using screen printing, the joining layer 42 (before curing) is formed. By this procedure, the bottom plate portion 40 including the anodic oxide layer 43 and the joining layer 42 is obtained.

[Disposition of Combined Product]

After the assembled combined product 10 is placed on the joining layer 42, they are maintained at the temperature corresponding to the material of the joining layer 42 to be cured. Then, the combined product 10 is fixed to the bottom plate portion 40. In particular, in connection with the reactor 1 of the present invention, since the surface of the bottom plate portion 40 has been subjected to surface roughening treatment, the contact area between the treatment area (herein the anodic oxide layer 43) and the constituent material of the joining layer 42 (herein an adhesive agent) can be fully increased, and excellent adhesion between them is exhibited. Herein, the anodic oxide layer 43 having a plurality of fine pores, dimples, and crack portions is included. Therefore, adhesion between the bottom plate portion 40 (the anodic oxide layer 43) and the joining layer 42 is further enhanced by the anchor effect of the constituent material of the joining layer 42. Accordingly, via the joining layer 42, the coil 2 (herein the combined product 10) and the bottom plate portion 40 can be closely attached to each other strongly.

Further, since the joining layer 42 fixes the position of the coil 2 and the outer core portion 32, eventually the position of the inner core portions 31 clamped between a pair of outer core portions 32 is also fixed. Accordingly, even in the situation where the inner core portions 31 and the outer core portions 32 are not joined by an adhesive agent or where the core pieces 31m and the gap members 31g are not integrated by being joined by an adhesive agent or an adhesive tape, the magnetic core 3 including the inner core portions 31 and the outer core portions 32 can be annularly integrated by the joining layer 42.

[Integration of Bottom Plate Portion and Sidewall Portion]

The combined product 10 is covered from above by the sidewall portion 41 such that the sidewall portion 41 surrounds the outer circumferential face of the combined product 10. Then, they are disposed on the bottom plate portion 40. Herein, the sidewall portion 41 can be disposed at an appropriate position relative to the bottom plate portion 40 using the overhanging portions of the sidewall portion 41 as stoppers. Then, the bottom plate portion 40 and the sidewall portion 41 are integrally connected to each other by the bolts or an adhesive agent as described above, whereby the case 4 is assembled. By this procedure, the box-like case 4 as shown in FIG. 1 is assembled, and the combined product 10 is stored in the case 4. Thus, the reactor 1 with no sealing resin can be obtained. Note that, in this mode, the end portions of the wire 2w and the terminal fittings 8 should be electrically connected to each other in the later procedure.

[Packing of Sealing Resin]

By packing the sealing resin (not shown) into the case 4 and curing the same, the reactor 1 including the sealing resin can be formed. In this mode, joining of the end portions of the wire 2w and the terminal fittings 8 may be performed after the sealing resin is packed. When the anodic oxide layer 43 being an anodized aluminum layer or the like is included, depending on the thickness thereof, the aforementioned cracks occur when the sealing resin is cured. Thus, the mode in which the constituent material of the joining layer 42, which is softened by the heat during curing, is packed inside the cracks is attained.

<<Uses>>

The reactor 1 structured as described above can be suitably used where the energizing conditions are as follows, for example: the maximum current (direct current) is about 100 A to 1000 A; the average voltage is about 100 V to 1000 V; and the working frequency is about 5 kHz to 100 kHz. Representatively, the reactor 1 can be suitably used as a constituent element of an in-vehicle power converter apparatus of an electric vehicle, a hybrid vehicle and the like.

<<Effect>>

In connection with the reactor 1 structured as described above, the bottom plate portion 40 and the sidewall portion 41 are independent separate members. The bottom plate portion 40 being brought into contact with the installation target such as a cooling base is made of a metal material. The coil 2 is joined to the bottom plate portion 40 by the joining layer 42. In particular, in connection with the reactor 1, the region in the bottom plate portion 40 where at least the joining layer 42 is formed has been subjected to surface roughening treatment (to be provided with the anodic oxide layer 43 herein), whereby minor unevenness is formed in the surface layer region of the bottom plate portion 40. Accordingly, the contact area between the bottom plate portion 40 and the joining layer 42 is sufficiently great, whereby the bottom plate portion 40 and the coil 2 can be strongly joined to each other. Accordingly, the reactor 1 can efficiently transfer the heat of the coil 2 to the installation target. Further, employing the mode in which the joining layer 42 is thin and the distance between the coil 2 and the bottom plate portion 40 is short, or the mode in which the joining layer 42 is made of a material with excellent thermal conductivity, the heat of the coil 2 can be more efficiently transferred to the installation target. Further, the surface area of the bottom plate portion 40 is increased by the unevenness. Based on these points, the reactor 1 exhibits an excellent heat dissipating characteristic. In particular, in the present embodiment, since the bottom plate portion 40 is made of aluminum alloy with excellent thermal conductivity, a further excellent heat dissipating characteristic is exhibited.

In addition, the reactor 1 according to the first embodiment provides the following effects.

(1) Thanks to excellent adhesion between the bottom plate portion 40 and the anodic oxide layer 43, and between the joining layer 42 and the anodic oxide layer 43, the coil 2 and the bottom plate portion 40 can be strongly joined to each other.

(2) Since the anodic oxide layer 43 is included, the insulating performance (withstand voltage, partial discharge inception voltage) can be improved.

(3) Since the bottom plate portion 40 and the sidewall portion 41 are separate members, in assembling the reactor 1, the burden associated with conveyance of the combined product 10 being a heavy item can be reduced. Further, the joining layer 42 can be formed and the combined product 10 can be disposed in the state where the sidewall portion 41 is removed. Thus, excellent productivity is exhibited.

(4) Since the sidewall portion 41 is made of an insulating resin, the reactor 1 is lightweight.

(5) Since the sidewall portion 41 is made of an insulating resin, the coil 2 and the sidewall portion 41 can be disposed in close proximity to each other, and hence the reactor 1 is small in size.

(6) Since the distance between the coil 2 and the bottom plate portion 40 is small (substantially being equal to the total thickness of the joining layer 42 and the anodic oxide layer 43), the reactor 1 is small in size.

(7) Since the magnetic core 3 also is in contact with the bottom plate portion 40 via the joining layer 42, heat can be dissipated also from the magnetic core 3, and an excellent heat dissipating characteristic is exhibited.

(8) Since a coated rectangular wire is used as the wire 2w to form an edgewise coil, the contact area between the coil 2 and the joining layer 42 is sufficiently great, and an excellent heat dissipating characteristic is exhibited.

[Variation 1]

In the section of the first embodiment, the description has been given of the mode in which the bottom plate portion 40 is made of a metal material, and the sidewall portion 41 is made of resin. However, both the bottom plate portion and the sidewall portion can be made of a metal material. In this mode, since the sidewall portion also can be used as the heat dissipation path, the heat dissipating characteristic can be enhanced. In this mode, when an anodic oxide layer is formed on the inner face of the sidewall portion, insulation between the coil and the sidewall portion can be enhanced.

### Test Example 1

Anodic oxidation treatment (aluminum anodizing) was carried out as surface roughening treatment, and the relationship between the surface roughening treatment and the joining strength was examined.

In this test, a plurality of rod-like test pieces (thickness: 0.15 mm, width: 10 mm) being rolled members made of aluminum alloy (A5052 in JIS standards) were prepared. The test pieces were subjected to aluminum anodizing as appropriate. One end portions of two rod-like test pieces were joined to each other by an adhesive agent. Thus, a joined test piece was obtained. Then, of the joined test piece, other end portion of one rod-like test piece and other end portion of other rod-like test piece were pulled in opposite directions, to measure the load when the rod-like test pieces peel (i.e., to measure the joining strength). The test was carried out using a commercially available tensile shear test machine. A commercially available epoxy-base adhesive agent (containing a filler) was used for each of the samples. After this adhesive agent was applied to one end portion of one rod-like test piece, one end portion of other rod-like test piece was joined and cured. The curing condition was common to the samples (140° C.×1.5 hours).

The joined test piece of Sample No. 100 is a sample in which none of two rod-like test pieces have been subjected to aluminum anodizing. The joined test pieces of Sample Nos. 1-1 and 1-2 are each a sample in which one rod-like test piece has entirely been subjected to aluminum anodizing. As to aluminum anodizing, known conditions were used and the thickness was varied by changing the treatment time (energizing time). Specifically, the treatment time of Sample No. 1-2 was set to be longer. The thickness of anodic oxide layer (anodized aluminum layer) is an average thickness that was obtained by carrying out aluminum anodizing, observing the cross-section using an optical microscope or a scanning electron microscope, and using the observed image.

TABLE 1

| | Anodic | | | | | | | |
|---|---|---|---|---|---|---|---|---|
| Sam- | oxide layer | | Joining strength in | | | | | |
| ple | thickness | | tensile shear test (MPa) | | | | | |
| No. | (μm) | Crack | ave | n = 1 | n = 2 | n = 3 | n = 4 | n = 5 |
| 100 | Absent | — | 15.8 | 14.7 | 16.7 | 16.1 | 15.3 | 16.1 |
| 1-1 | 3 | Absent | 8.3 | 8.2 | 8.0 | 8.6 | — | — |
| 1-2 | 12 | Present | 18.3 | 17.4 | 19.6 | 17.8 | 17.6 | 19.2 |

As shown in Table 1, it can be seen that Sample No. 1-2 having a thick anodic oxide layer exhibits high joining strength.

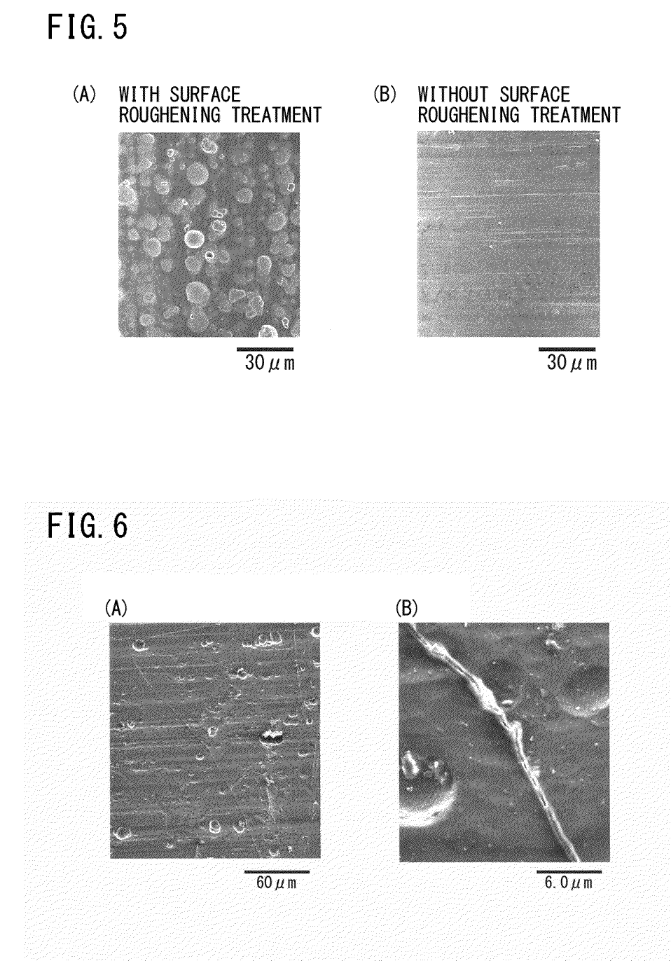

FIG. 5 (A) is an SEM photomicrograph of the surface of the rod-like test piece having been subjected to aluminum anodizing and used as Sample No. 1-2, and FIG. 5 (B) is an SEM photomicrograph of the surface of the rod-like test piece used as Sample No. 100. As shown in FIG. 5 (A), it can be seen that, when being subjected to aluminum anodizing, a plurality of dimples (herein, each having a diameter of about 5 μm to 15 μm) or very minor fine pores are present on the surface, and the surface is in an uneven shape. On the other hand, while FIG. 5 (B) shows rolling trace in streaks, the rolling trace is shallow, and the sample does not substantially have unevenness. Based on these points, it can be considered that the joining strength was improved because minor unevenness were formed on the surface of Sample No. 1-2 by the aluminum anodizing, and the contact area relative to the adhesive agent was sufficiently great. Further, with Sample No. 1-2, since the thickness of the anodic oxide layer was sufficiently thick, i.e., 10 μm or more, the depth of the fine pores became sufficiently deep. It is considered that joining strength was enhanced thanks to the anchor effect, which was achieved by the adhesive agent being packed into the fine pores.

Further, after the joined test pieces of Sample Nos. 1-1 and 1-2 were separately fabricated as described above, the adhesive agent attached to the surface of each rod-like test piece was removed, and the surface of each of the samples was observed using a scanning electron microscope (SEM). It was observed that Sample No. 1-2 had a plurality of cracks (appearing in streaks) as shown in FIG. 6 (A). In particular, in the photomicrograph of FIG. 6 (A), it was observed that cracks whose length was on the order of millimeter were present, and that cracks were present in a mesh-like manner. Further magnifying a crack part, as shown in FIG. 6 (B), it was observed that the adhesive agent was leaked out from the crack part. Based on this point, it can be said that the crack part is packed with the adhesive agent. Further, is can be said that Sample No. 1-2 had a crack portion packed with the adhesive agent. On the other hand, with Sample No. 1-1, no crack was observed.

Further, when the presence and absence of cracks was examined with different thickness of the anodic oxide layer and with the heat treatment under the same condition as the curing condition as described above, it was found that cracks are sufficiently present when the thickness of the anodic oxide layer is 9 μm or more, and cracks are small or absent when the thickness of the anodic oxide layer is less than 6 μm. Based on this point, it is considered that cracks of the anodic oxide layer occur by thermal hysteresis after the anodic oxidation treatment. Further, it can be said that the cracks are prone to occur when the anodic oxide layer is thick to some degree, even when the thermal hysteresis is the same.

From this test, it can be considered that joining strength of Sample No. 1-2 was improved thanks to, in addition to the anchor effect attained by the minor unevenness formed by the anodic oxidation treatment, an increase in the contact area relative to the adhesive agent that was achieved by the cracks occurred by the thick anodic oxide layer and thermal hysteresis.

Further, when the similar test was performed replacing the adhesive agent by a commercially available sheet-like adhesive agent (epoxy-base resin), the joining strength (average) at the tensile shear test was 20 MPa or more, and the joining strength was further enhanced. Based on this point, it can be said that the joining strength can be more enhanced by the type of the adhesive agent.

### Test Example 2

The reactor according to the first embodiment was tentatively fabricated, to examine the joining state between the bottom plate portion and the joining layer.

In the present test, as the bottom plate portion, a plate member being a rolled member made of aluminum alloy (A5052 in JIS standards) was prepared. The bottom plate portion was subjected to anodic oxidation treatment (aluminum anodizing) as surface roughening treatment, to form an anodic oxide layer having a thickness of 12 μm. Thereafter, an epoxy-base adhesive agent (containing a filler) used in Test Example 1 was applied thereto. A combined product made up of the coil and the magnetic core was disposed on the adhesive agent, and the adhesive agent was cured. The curing condition was identical to that in Test Example 1 (140° C.×1.5 hours). By this procedure, the joining layer made of an adhesive agent was formed. Note that, the sidewall portion was omitted in the present test.

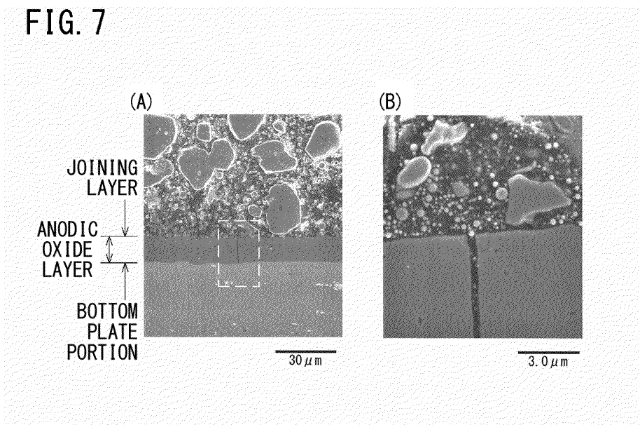

The obtained prototype reactor was cut in cross section, and the region in which the stacked state of the bottom plate portion, the anodic oxide layer, and the joining layer could be observed was adopted as the observation field. The observation field was observed by a scanning electron microscope (SEM). As a result, as shown in the quadrangular frame formed by a white dashed line in FIG. 7 (A), it was found that cracks were present from the surface of the anodic oxide layer toward the metal forming the bottom plate portion. Further, as shown in FIG. 7 (B) in an enlarged manner, it was found that the cracks were packed with the adhesive agent forming the joining layer.

Accordingly, from Test Examples 1 and 2, it was found that, in the situation where anodic oxidation treatment is employed as surface roughening treatment, an increase in the thickness of the anodic oxide layer (preferably 9 μm or more, particularly 12 μm or more) and the anodic oxide layer undergoing appropriate thermal hysteresis form cracks originating from the surface of the anodic oxide layer to the bottom plate portion. Then, it was found that the reactor including a plurality of crack portions packed with the constituent material of the joining layer in addition to the fine pores and dimples of the anodic oxide layer exhibits high joining strength, because the coil and the bottom plate portion of the case are fully closely attached to each other. This is achieved by the sufficiently great joining area between the anodic oxide layer and the joining layer, and the anchor effect attained by the crack portions packed with the constituent material of the joining layer.

### Test Example 3

The relationship between the anodic oxide layer and the insulating characteristic was examined.

As a comparative sample, a rolled plate of an aluminum alloy (A5052 in JIS standards) was prepared. On the surface of the comparative sample, an insulating sheet (a commercially available polyimide film (thickness: 0.025 mm)) was disposed. Further, an electrode was disposed on the insulating sheet, and the partial discharge inception voltage was measured by connecting the electrode and the rolled plate of the comparative sample to a power supply. As a result, the measured voltage was about 690 V to 705 V.

On the other hand, as Sample No. 3-1, a rolled plate made of aluminum alloy (A5052 in JIS standards) was prepared. Similarly to Test Example 2, an anodic oxide layer having a thickness of 12 μm was formed on part of the surface of the rolled plate. On the anodic oxide layer, an insulating sheet identical to that of the comparative sample, i.e., a polyimide film, was disposed. Further, an electrode was disposed on the insulating sheet. Then, the partial discharge inception voltage was measured by connecting the electrode and a portion of the rolled plate being Sample No. 3-1 where the anodic oxide layer is not formed to a power supply. As a result, the measured voltage was about 760 V to 780 V.

From the present test, it was found that an excellent electrical insulating performance also is achieved by adopting anodic oxidation treatment as surface roughening treatment and including the anodic oxide layer.

### Second Embodiment

The reactor according to any of the first embodiment and the Variation 1 can be used as a constituent element of a converter mounted, for example, on a vehicle or as a constituent element of a power converter apparatus including the converter.

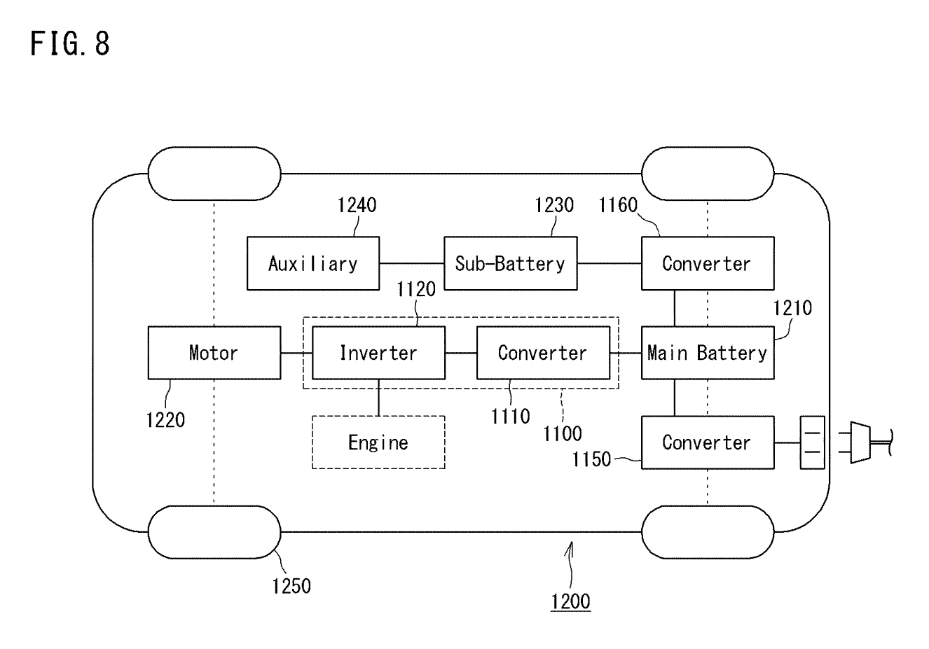

For example, as shown in FIG. 8, a vehicle 1200 such as a hybrid vehicle or an electric vehicle includes a main battery 1210, a power converter apparatus 1100 connected to the main battery 1210, and a motor (load) 1220 driven by power supplied from the main battery 1210 and used for traveling. The motor 1220 is representatively a three-phase alternating current motor. The motor 1220 drives wheels 1250 in the traveling mode and functions as a generator in the regenerative mode. When the vehicle is a hybrid vehicle, the vehicle 1200 includes an engine in addition to the motor 1220. Though an inlet is shown as a charging portion of the vehicle 1200 in FIG. 8, a plug may be included.

The power converter apparatus 1100 includes a converter 1110 connected to the main battery 1210, and an inverter 1120 connected to the converter 1110 to perform interconversion between direct current and alternating current. When the vehicle 1200 is in the traveling mode, the converter 1110 in the present embodiment steps up DC voltage (input voltage) of approximately 200 V to 300 V of the main battery 1210 to approximately 400 V to 700 V, and supplies the inverter 1120 with the stepped up power. Further, in the regenerative mode, the converter 1110 steps down DC voltage (input voltage) output from the motor 1220 through the inverter 1120 to DC voltage suitable for the main battery 1210, such that the main battery 1210 is charged with the DC voltage. When the vehicle 1200 is in the traveling mode, the inverter 1120 converts the direct current stepped up by the converter 1110 to a prescribed alternating current, and supplies the motor 1220 with the converted power. In the regenerative mode, the inverter 1120 converts the AC output from the motor 1220 into direct current, and outputs the direct current to the converter 1110.

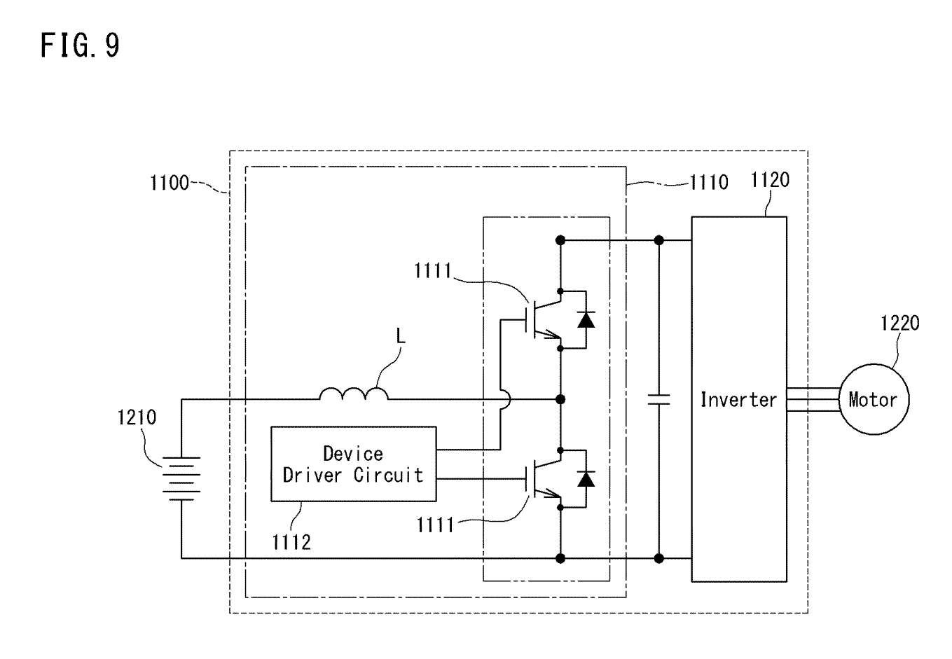

As shown in FIG. 9, the converter 1110 includes a plurality of switching elements 1111, a driver circuit 1112 that controls operations of the switching elements 1111, and a reactor L. The converter 1110 converts (herein, performs step up and down) the input voltage by repetitively performing ON/OFF (switching operations). As the switching elements 1111, power devices such as FETs and IGBTs are used. The reactor L uses a characteristic of a coil that disturbs a change of current which flows through the circuit, and hence has a function of making the change smooth when the current is increased or decreased by the switching operation. The reactor L is the reactor according to any of the first embodiment and the Variation 1. Since the reactor 1 with excellent heat dissipating characteristic is included, the power converter apparatus 1100 and the converter 1110 also have excellent heat dissipating characteristic.

The vehicle 1200 includes, in addition to the converter 1110, a power supply apparatus-use converter 1150 connected to the main battery 1210, and an auxiliary power supply-use converter 1160 connected to a sub-battery 1230 serving as a power supply of auxiliary equipment 1240 and to the main battery 1210, to convert a high voltage of the main battery 1210 to a low voltage. The converter 1110 representatively performs DC-DC conversion, whereas the power supply apparatus-use converter 1150 and the auxiliary power supply-use converter 1160 perform AC-DC conversion. Some types of the power supply apparatus-use converter 1150 perform DC-DC conversion. The power supply apparatus-use converter 1150 and the auxiliary power supply-use converter 1160 each may include a configuration similar to the reactor according to any of the first embodiment and the Variation 1, and the reactor with size and shape changed as appropriate may be used. Further, the reactor according to the first embodiment may be used as a converter that performs conversion for the input power and that performs only stepping up or stepping down.

Note that the present invention is not limited to the embodiments described above, and can be changed as appropriate within the scope not deviating from the gist of the present invention.

### INDUSTRIAL APPLICABILITY

The reactor of the present invention can be suitably used as a constituent element of a power converter apparatus, such as an in-vehicle converter (representatively, a DC-DC converter) mounted on a vehicle such as a hybrid vehicle, a plug-in hybrid vehicle, an electric vehicle, a fuel cell vehicle, or a converter of an air conditioner.

### REFERENCE SIGNS LIST

1: REACTOR
10: COMBINED PRODUCT
2: COIL
2a, 2b: COIL ELEMENT
2r: COIL COUPLING PORTION
2w: WIRE
3: MAGNETIC CORE
31: INNER CORE PORTION
31e: END FACE
31m: CORE PIECE
31g: GAP MEMBER
32: OUTER CORE PORTION
32e: INNER END FACE
4: CASE
40: BOTTOM PLATE PORTION
40i: INNER FACE
41: SIDEWALL PORTION
400, 411: ATTACHING PORTION
400h, 411h: BOLT HOLE
410: TERMINAL BLOCK
410c: CONCAVE GROOVE
42: JOINING LAYER
43: ANODIC OXIDE LAYER
5: INSULATOR
51: CIRCUMFERENTIAL WALL PORTION
52: FRAME PLATE PORTION
52b: PARTITION PLATE
52p: PEDESTAL
8: TERMINAL FITTING
81: ONE END PORTION
9: TERMINAL FIXING MEMBER
91: BOLT
1100: POWER CONVERTER APPARATUS
1110: CONVERTER
1111: SWITCHING ELEMENT
1112: DRIVER CIRCUIT
L: REACTOR
1120: INVERTER
1150: POWER SUPPLY APPARATUS-USE CONVERTER
1160: AUXILIARY POWER SUPPLY-USE CONVERTER
1200: VEHICLE
1210: MAIN BATTERY
1220: MOTOR
1230: SUB-BATTERY
1240: AUXILIARY EQUIPMENT
1250: WHEELS

1. A reactor comprising:
a coil;
a magnetic core in which the coil is disposed; and
a case that stores a combined product made up of the coil and the magnetic core, wherein the case includes
a bottom plate portion made of a metal material,
a sidewall portion that is a member independent of the bottom plate portion, the sidewall portion being attached to the bottom plate portion to surround the combined product, and
a joining layer that is provided at an inner face of the bottom plate portion to fix the coil, wherein
in the inner face of the bottom plate portion, a region at least provided with the joining layer has been subjected to surface roughening treatment.

2. The reactor according to claim 1, wherein
the surface roughening treatment is anodic oxidation treatment, and
the bottom plate portion includes an anodic oxide layer at the inner face of the bottom plate portion.

3. The reactor according to claim 2, wherein
a thickness of the anodic oxide layer is 2 μm or more and 20 μm or less.

4. The reactor according to claim 3, wherein
the anodic oxide layer has a crack portion originating from a surface of the anodic oxide layer to reach a metal material forming the bottom plate portion, wherein
the crack portion is packed with a constituent material of the joining layer.

5. The reactor according to claim 2, wherein
a portion of the bottom plate portion is not provided with the anodic oxide layer and the metal material is exposed, and
the exposed portion is an attaching place for a ground wire.

6. The reactor according to claim 1, wherein
the sidewall portion is made of an insulating resin.

7. The reactor according to claim 1, wherein
a total thickness of the joining layer is 2 mm or less.

8. A converter comprising:
a switching element;
a driver circuit that controls an operation of the switching element; and
a reactor that smoothes a switching operation, wherein
an input voltage is converted by the operation of the switching element, and
the reactor is the reactor according to claim 1.

9. A power converter apparatus comprising:
a converter that converts an input voltage; and
an inverter that is connected to the converter to interconvert direct current and alternating current, a load being driven by power converted by the inverter, wherein
the converter is the converter according to claim 8.
